(19) United States
(12) Patent Application Publication
(10) Pub. No.: US 2025/0230020 A1
(43) Pub. Date: Jul. 17, 2025

(54) WALL GRABBING SYSTEM AND METHOD FOR GRABBING A WALL STRUCTURE FOR A MODULAR CONSTRUCTION UNIT

(71) Applicant: Buildz, LLC, Forest City, NC (US)

(72) Inventors: Mark Joseph BELLISSIMO, Wellington, FL (US); Stanley Clark Beard, JR., Hendersonville, NC (US); Jason Daryl Hunsinger, Forest City, NC (US); Benjamin Austin Tucker, Boiling Springs, SC (US)

(21) Appl. No.: 19/016,947

(22) Filed: Jan. 10, 2025

Related U.S. Application Data
(60) Provisional application No. 63/620,458, filed on Jan. 12, 2024.

(51) Int. Cl. B66C 1/30

(52) U.S. Cl. CPC B66C 1/30

(57) ABSTRACT

A wall grabbing system and method of grabbing a wall structure of a modular construction unit. The wall grabbing system includes a machine attachment structure and a wall grabbing device coupled to the machine attachment structure. The wall grabbing device includes a frame assembly having one or more wall guides and a hook assembly coupled to the frame assembly between the one or more wall guides. The hook assembly includes one or more hooks and an actuator. The one or more hooks are configured to engage the wall structure. The actuator is coupled to the frame assembly and includes an actuator shaft coupled to the hook assembly. The actuator moves the hook assembly from an extended position to a retracted position such that the one or more hooks engage the wall structure in the retracted position to grab the wall structure.

### CROSS REFERENCE TO RELATED APPLICATIONS

This application claims the benefit of U.S. Provisional Patent Application No. 63/620,458, filed on Jan. 12, 2024, the entire contents of which is hereby incorporated by reference in its entirety.

### TECHNICAL FIELD

The present disclosure relates generally to construction of modular construction units. In particular, the present disclosure relates to a wall grabbing system and method for grabbing a wall structure for a modular construction unit.

### BACKGROUND

The production of modular, or prefabricated, buildings is a growing industry. In this type of manufacturing, sections of a building or structure, also referred to as a modular construction unit, are partially assembled at a remote location, and the sections are then delivered to the final building site, where final construction of the structure is ultimately completed by assembling the various sections together. Such modular construction units can be used for a variety of purposes, including, for example, as temporary or permanent buildings, such as residential homes, commercial offices, educational or service facilities, etc. Wall structures of the modular construction unit are heavy and need to be lifted and transported to a location for installing the wall structure in the modular construction unit.

### SUMMARY

A wall grabbing system for grabbing a wall structure of a modular construction unit includes a machine attachment structure and a wall grabbing device coupled to the machine attachment structure. The wall grabbing device in a frame assembly having one or more wall guides and a hook assembly coupled to the frame assembly between the one or more wall guides. The hook assembly includes one or more hooks configured to engage the wall structure and an actuator coupled to the frame assembly and having an actuator shaft coupled to the hook assembly. The actuator moves the hook assembly from an extended position to a retracted position such that the one or more hooks engage the wall structure in the retracted position to grab the wall structure.

A method of grabbing a wall structure of a modular construction unit includes lowering a wall grabbing device onto the wall structure, and guiding the wall grabbing device onto the wall structure with one or more wall guides of a frame assembly as the wall grabbing device is lowered onto the wall structure. When the wall grabbing device is on the wall structure, the method includes retracting a hook assembly of the wall grabbing device to a retracted position such that one or more hooks of the hook assembly engage the wall structure to grab the wall structure with the wall grabbing device, and lifting the wall grabbing device to lift the wall structure.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1A is a perspective view of a wall grabbing system for grabbing a wall structure for a modular construction unit, according to the present disclosure.

FIG. 1B is an enlarged perspective view of a wall grabbing device of the wall grabbing system, taken at detail 1B in FIG. 1A, according to the present disclosure.

FIG. 1C is an enlarged perspective view of the wall grabbing system, according to the present disclosure.

FIG. 2A is a perspective view of the wall grabbing device isolated from the wall grabbing system, according to the present disclosure.

FIG. 2B is a side plan view of the wall grabbing device of FIG. 2A, according to the present disclosure.

FIG. 2C is a front plan view of the wall grabbing device of FIG. 2A, according to the present disclosure.

FIG. 3 is a perspective view of the wall grabbing device with a hook assembly removed from the wall grabbing device, according to the present disclosure.

FIG. 4A is a perspective view of a wall grabbing device base assembly of the wall grabbing device and isolated from the wall grabbing device, according to the present disclosure.

FIG. 4B is a side plan view of the wall grabbing device base assembly of FIG. 4A, according to the present disclosure.

FIG. 4C is a front plan view of the wall grabbing device base assembly of FIG. 4A, according to the present disclosure.

FIG. 4D is a rear plan view of the wall grabbing device base assembly of FIG. 4A, according to the present disclosure.

FIG. 4E is a top plan view of the wall grabbing device base assembly of FIG. 4A, according to the present disclosure.

FIG. 4F is a bottom plan view of the wall grabbing device base assembly of FIG. 4A, according to the present disclosure.

FIG. 5 is a perspective view of a hook assembly of the wall grabbing device and isolated from the wall grabbing device, according to the present disclosure.

FIG. 6A is a perspective view of the wall grabbing device in an extended position, according to the present disclosure.

FIG. 6B is a side plan view of the wall grabbing device in the extended position, according to the present disclosure.

FIG. 7A is a perspective view of the wall grabbing device in a retracted position, according to the present disclosure.

FIG. 7B is a side plan view of the wall grabbing device in the retracted position, according to the present disclosure.

FIG. 8 is a flow diagram of a method of grabbing a wall structure of a modular construction unit, according to the present disclosure.

FIG. 9 illustrates a computing device for controlling aspects of the wall grabbing system, according to the present disclosure.

### DETAILED DESCRIPTION

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first” and “second,”, etc., may be used interchangeably to distinguish one component from another and are not intended to signify location or importance of the individual components.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

As mentioned above, wall structures, for example, for modular construction units are heavy. Transporting the wall structures (e.g., pre-built walls) and placing the wall structures in their installation location requires the ability to lift and to move the heavy wall structures. Accordingly, the present disclosure provides a wall grabbing system having a wall grabbing device that can easily move and place wall structures at a desired location. The wall grabbing device is attached to a beam which attaches to a machine, such as a forklift. The wall grabbing device is lowered over a wall structure. After the wall grabbing device is lowered over a wall structure, actuated hooks grab the top plate of the wall structure (e.g., a top portion of a wall frame of the wall structure). Once the hooks are secured around the top plate, the machine moves to a desired location. Thus, the present disclosure provides for an improved wall grabbing device that securely grabs and balances the wall structures, providing the ability to move and place wall structures safely, quickly, and with ease to build the modular construction units.

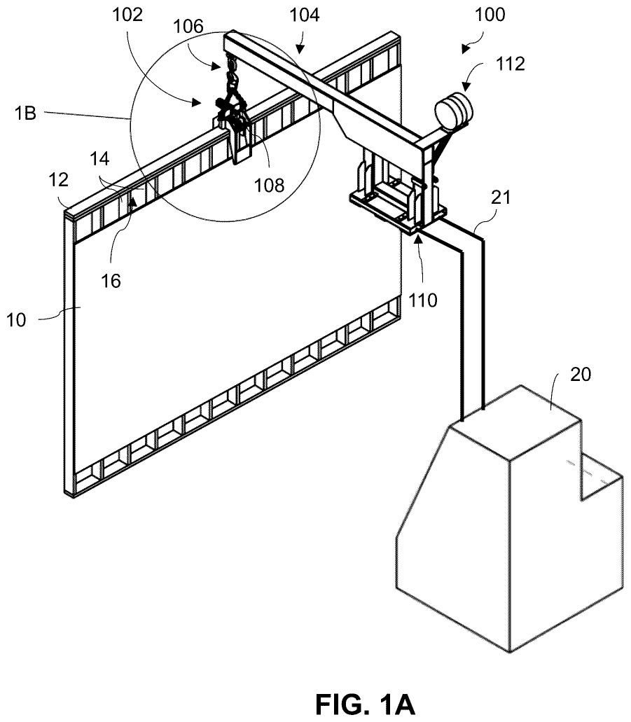

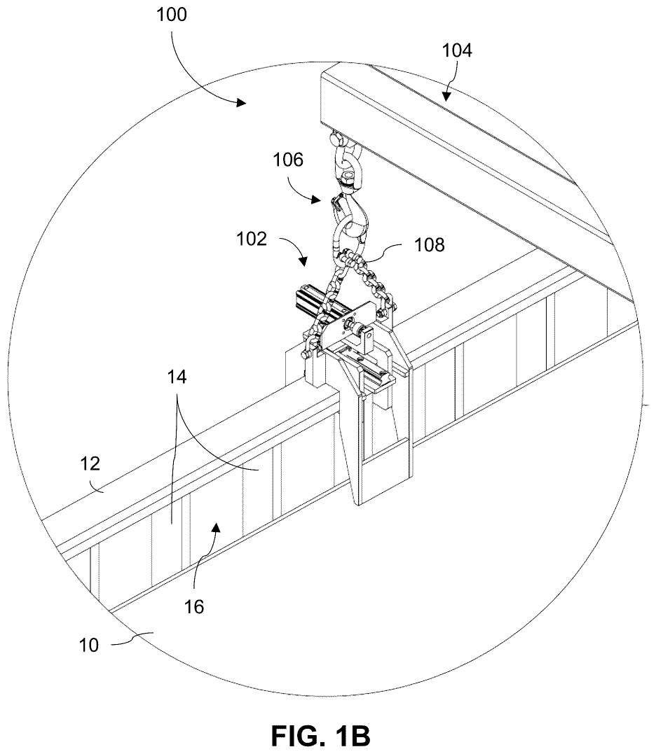

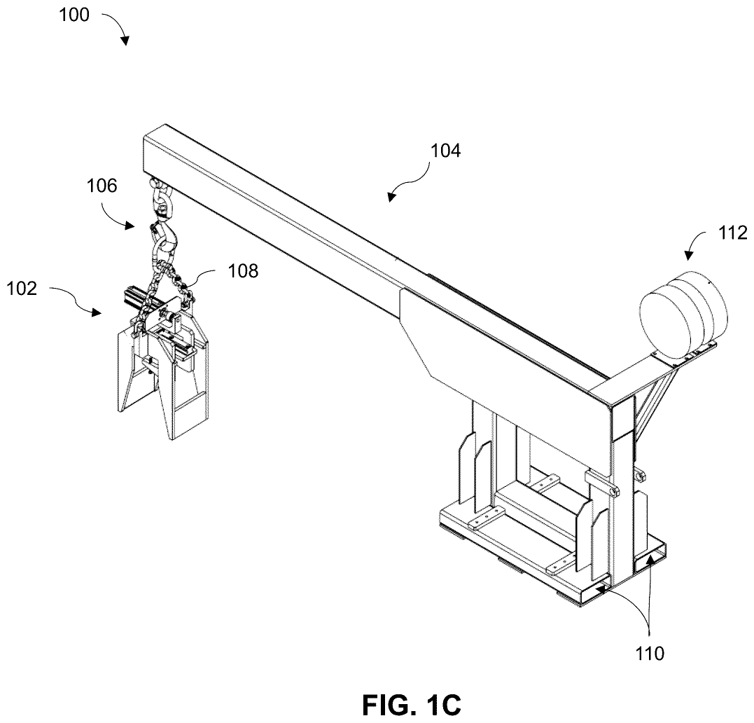

Referring now to the drawings, FIG. 1A is a perspective view of a wall grabbing system 100 for grabbing a wall structure 10 for a modular construction unit, according to the present disclosure. FIG. 1B is an enlarged perspective view of a wall grabbing device 102 of the wall grabbing system 100, taken at detail 1B in FIG. 1A, according to the present disclosure. FIG. 1C is an enlarged perspective view of the wall grabbing system 100, according to the present disclosure.

The wall structure 10 can be constructed in a system for creating the wall structures for use in creating a modular construction unit. The modular construction unit is, for example, a modular room that is built in a factory, transported in a substantially assembled state to a construction site, and secure to form a larger building, such as, for example, a hotel constructed from a plurality of such modular construction units. By way of example, the system for creating the wall structures 10 may be the system described in U.S. Patent Application Publication No. US2021/0187783, the contents of which are hereby incorporated by reference in their entirety. The wall grabbing system 100 can be included in the system for grabbing the wall structures 10 from a storage magazine to transport completed wall structures 10 from the storage magazine to a location at which the wall structure 10 will be installed in the modular construction unit. Each wall structure 10 includes a wall frame 12 including a plurality of studs 14 that define a wall cavity 16 therebetween.

As shown in FIG. 1A, the wall grabbing system 100 includes the wall grabbing device 102, a machine attachment frame 104, and a wall grabbing device coupling 106. The wall grabbing device 102 is a device that is actuated to grab the wall structure 10 for lifting the wall structure 10 and transporting the wall structure 10, as detailed further below. The machine attachment frame 104 attaches to a machine 20, for example, by one or more machine attachment devices 21 of the machine 20 such that the machine (e.g., by an operator input or automatically by a processor) can control the wall grabbing device 102 with the machine 20. In FIG. 1A, the machine 20 is a forklift and the machine attachment devices 21 are forks of the forklift. The machine attachment frame 104, however, can be adapted to attach to any type of machine for controlling the wall grabbing device 102 to grab the wall structures 10 and to transport the wall structures 10. The wall grabbing device 102 is coupled to the machine attachment frame 104 by the wall grabbing device coupling 106. The wall grabbing device coupling 106 can include any type of coupling mechanism for coupling the wall grabbing device 102 to the machine attachment frame 104. In FIGS. 1A to 1C, the wall grabbing device coupling 106 is a hook and the wall grabbing device 102 includes a chain 108 that is hooked onto the hook. In this way, the wall grabbing device 102 is removably coupled to the machine attachment frame 104.

The wall grabbing system 100 also includes one or more fork pockets, also referred to as one or more machine attachment slots 110. The one or more machine attachment slots 110 allow the machine 20 to couple, to lift, and to control, the wall grabbing system 100. In particular, the one or more machine attachment slots 110 are sized to receive the machine attachment devices 21 of the machine 20 therein. In this way, an operator can control the machine 20 to insert the machine attachment devices 21 into the one or more machine attachment slots 110 such that the machine 20 can lift the wall grabbing system 100 and control the wall grabbing device 102 to grab and to lift the wall structures 10.

The wall grabbing system 100 includes one or more air hose reels, also referred to as one or more actuator line reels 112. The one or more actuator line reels 112 house actuator lines (e.g., air hoses, electrical lines, hydraulic lines, or the like) to supply actuator power (e.g., air or gas, electricity, or hydraulics) to an actuator of the wall grabbing device 102 to actuate the wall grabbing device 102 to grab the wall structures 10, as detailed further below. In one embodiment, the one or more actuator line reels 112 are air hose reels that supply air (e.g., compressed air) to the wall grabbing device 102 to actuate the wall grabbing device 102 to grab the wall structures 10. The actuator line reels 112 are retractable such that the actuator lines therein can be retracted and stored, or can be extended to couple to the wall grabbing device 102. The actuator lines can extend along the machine attachment frame 104 to the wall grabbing device 102.

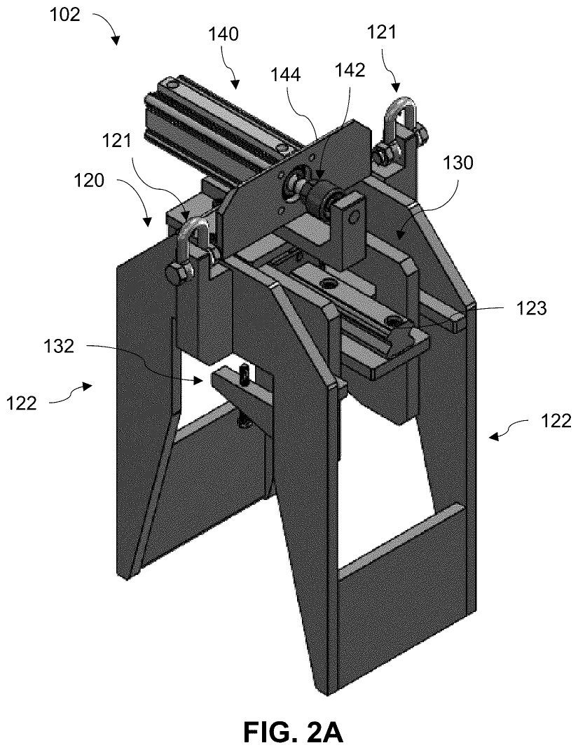

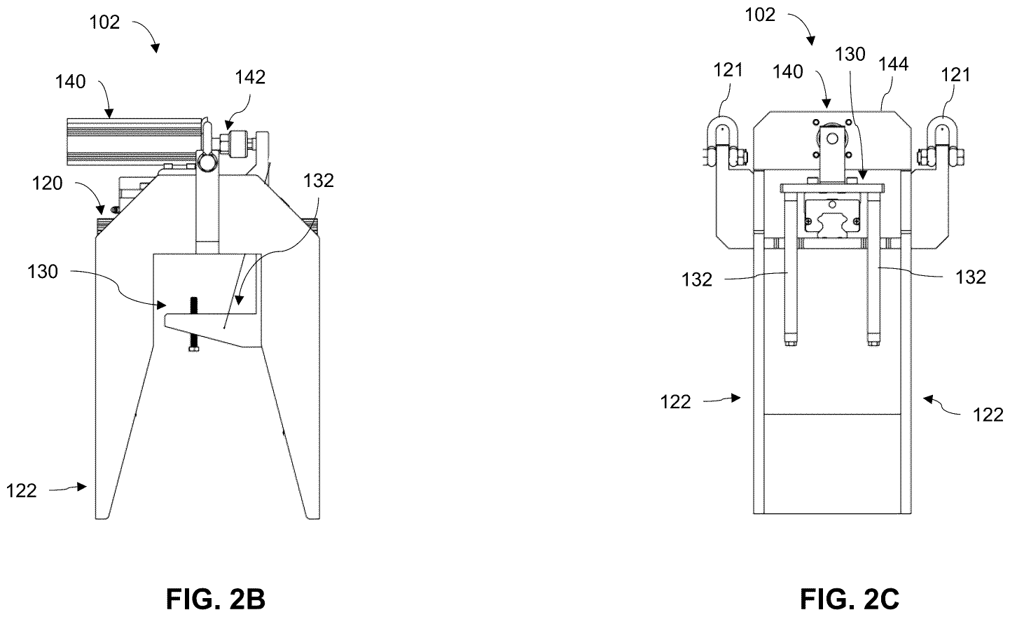

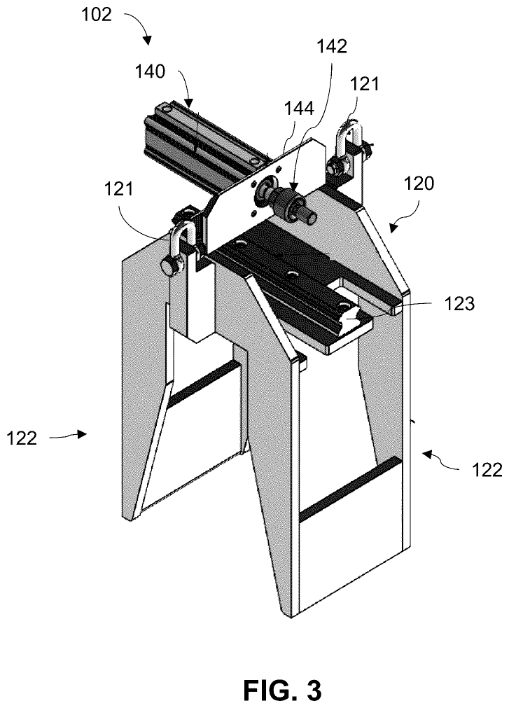

FIG. 2A is a perspective view of the wall grabbing device 102 isolated from the wall grabbing system 100, according to the present disclosure. FIG. 2B is a side plan view of the wall grabbing device 102 of FIG. 2A, according to the present disclosure. FIG. 2C is a front plan view of the wall grabbing device 102 of FIG. 2A, according to the present disclosure. FIG. 3 is a perspective view of the wall grabbing device 102 with a hook assembly 130 of the wall grabbing device 102 removed from the wall grabbing device 102, according to the present disclosure. In general, the wall grabbing device 102 includes a frame assembly 120, the hook assembly 130, and an actuator 140.

The frame assembly 120 includes one or more wall grabbing device coupling mechanisms 121, one or more wall guides 122, and one or more frame assembly tracks 123. The one or more wall grabbing device coupling mechanisms 121 include shackles (e.g., made of steel, or the like) that receive the chain 108 for coupling the wall grabbing device 102 to the machine attachment frame 104. The one or more wall grabbing device coupling mechanisms 121 can include any type of coupling mechanism for coupling the wall grabbing device 102 to the machine attachment frame 104. The one or more wall grabbing device coupling mechanisms 121 include two wall grabbing device coupling mechanisms, but can include any number of wall grabbing device coupling mechanisms, as desired or as necessary for coupling the wall grabbing device 102 to the machine attachment frame 104. The one or more wall guides 122 are generally U-shaped structures that provide a guide about the wall structures 10 as the wall grabbing device 102 moves about the wall structures 10 before grabbing the wall structures 10, as detailed further below. The frame assembly 120 includes two wall guides 122, but can include any number of wall guides 122, as necessary, for guiding the wall grabbing device 102 onto the wall structure 10.

The hook assembly 130 includes one or more hooks 132. The one or more hooks 132 are sized and shaped to hook onto the wall frame 12 for grabbing the wall structure 10. The hook assembly 130 is disposed between the wall guides 122 and the hooks 132 are parallel with the wall guides 122. The hook assembly 130 is coupled to the actuator 140 such that the actuator 140 moves the hooks 132 to engage the wall frame 12, as detailed further below. The hook assembly 130 is movably coupled on the one or more frame assembly tracks 123 of the frame assembly 120. In this way, the hook assembly 130 moves along the one or more frame assembly tracks 123.

The actuator 140 includes an actuator shaft 142 and an actuator mount 144. The actuator 140 is a linear actuator that is powered by air (e.g., pneumatic actuator) to extend and to retract the actuator shaft 142. The actuator shaft 142 is coupled to the hook assembly 130 such that the actuator 140 extends and retracts the hook assembly 130, as detailed further below. The actuator mount 144 is coupled to frame assembly 120. For example, the actuator mount 144 extends between the wall guides 122. The actuator 140 is mounted to the actuator mount 144 such that the actuator 140 is coupled to the frame assembly 120. In this way, the actuator 140 moves the hook assembly 130 with respect to the wall guides 122, as detailed further below.

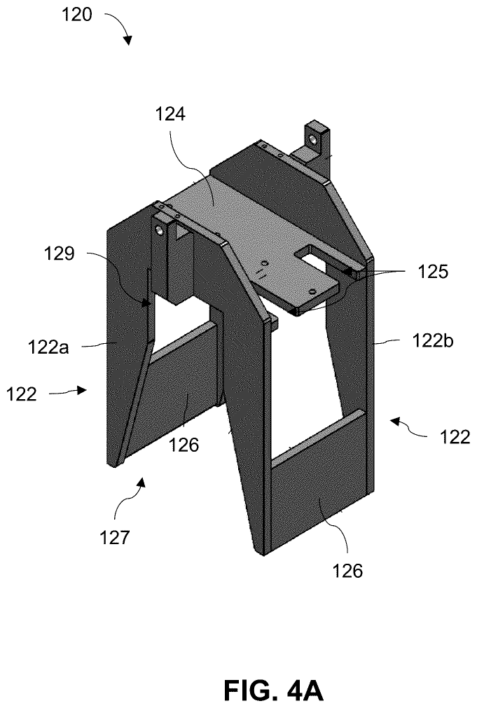

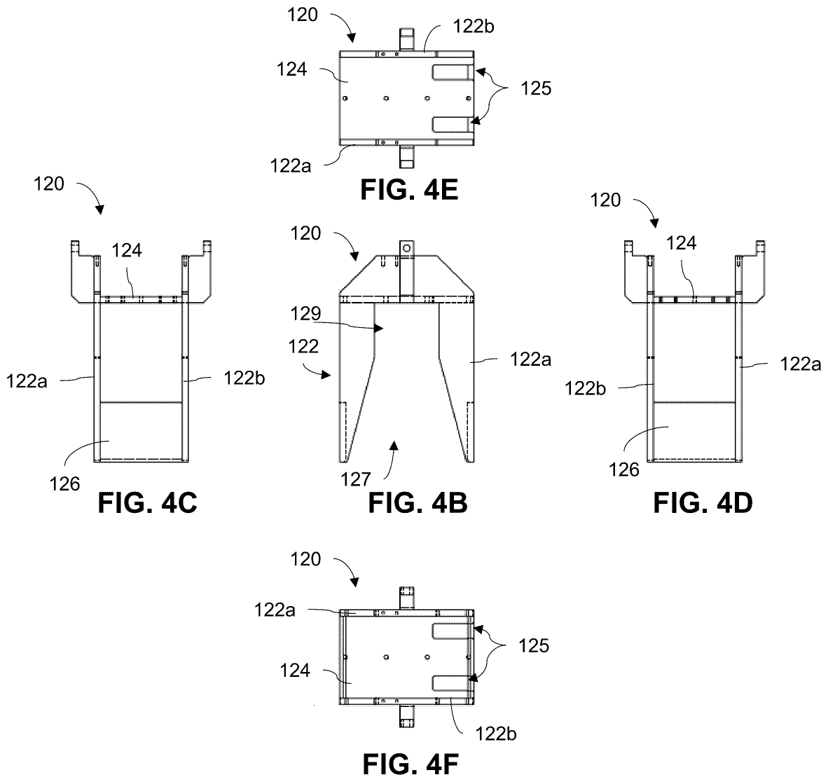

FIG. 4A is a perspective view of the frame assembly 120 isolated from the wall grabbing device 102, according to the present disclosure. FIGS. 4B-4F are a side plan view, a front plan view, a rear plan view, a top plan view, and a bottom plan view, respectively, of the frame assembly 120 of FIG. 4A, according to the present disclosure. The frame assembly 120 includes a frame assembly base 124. The frame assembly base 124 includes one or more hook slots 125 such that the hooks 132 of the hook assembly 130 can move into and out of the hook slots 125 of the frame assembly base 124 as the hook assembly 130 extends and retracts. The hook assembly 130 is movably coupled to a top side of the frame assembly base 124 such that the one or more hooks 132 extend beyond a bottom side the frame assembly base 124.

The wall guides 122 are coupled to the frame assembly base 124 on opposite lateral sides of the frame assembly base 124. In particular, the wall guides 122 include a first wall guide 122a coupled to a first lateral side of the frame assembly base 124, and a second wall guide 122b coupled to a second lateral side of the frame assembly base 124. In this way, the second wall guide 122b is spaced laterally from the first wall guide 122a. The frame assembly 120 includes one or more wall guide connector plates 126 that extend from the first wall guide 122a to the second wall guide 122b for coupling the second wall guide 122b to the first wall guide 122a. The wall guide connector plates 126 also lower a center of mass of the frame assembly 120 to add stability to the frame assembly 120 when positioned on top of the wall structure 10.

Each of the wall guides 122 includes a tapered wall guide portion 127 and a straight wall guide portion 129. The tapered wall guide portion 127 guides the wall grabbing device 102 about the wall structure 10 as the wall grabbing device 102 is moved to a position to grab the wall structure 10. The tapered wall guide portion 127 is also referred to as a wall funneling lead-in portion such that the tapered wall guide portion 127 positions the wall grabbing device 102 on the wall structure 10 as the wall grabbing device 102 is lowered on the wall structure 10. The straight wall guide portion 129 is sized to receive the top of the wall frame 12 and to grip the top of the wall frame 12 when the wall grabbing device 102 is lowered onto the wall structure 10.

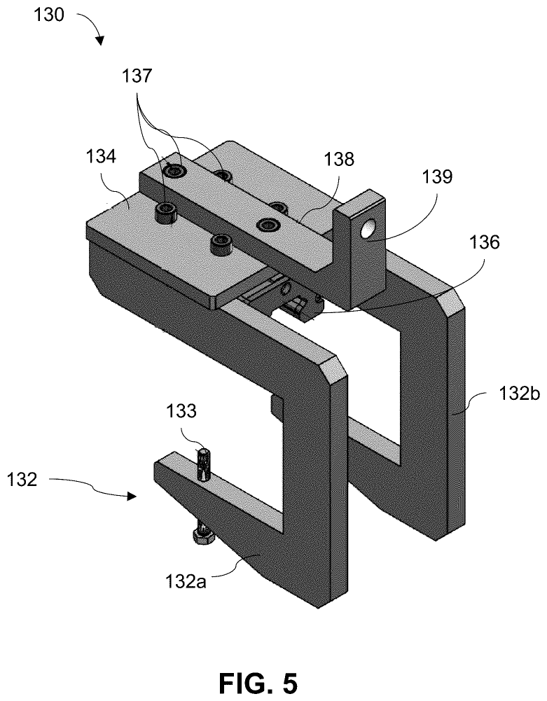

FIG. 5 is a perspective view of the hook assembly 130 isolated from the wall grabbing device 102, according to the present disclosure. As shown in FIG. 5, the one or more hooks 132 include a first hook 132a and a second hook 132b. While two hooks 132 are shown in FIG. 5, the one or more hooks 132 can include any number of hooks, as desired or as necessary for grabbing a wall structure 10. The second hook 132b is spaced laterally from the first hook 132a. The hooks 132 are sized and shaped to engage the wall frame 12 and to hold the wall frame 12 thereon such that the wall grabbing device 102 can lift the wall structure 10, as detailed further below. Each hook 132 includes a rod member 133 that extends vertically from a respective hook 132. The rod member 133 helps to grip the wall frame 12 between the rod member 133 and a rear surface of the hooks 132. In FIG. 5, the rod member 133 is a screw, but can include any type of rod member 133 for gripping the wall frame 12 between the rod member 133 and the hooks 132 when the hook assembly 130 engages the wall frame 12.

The hook assembly 130 also includes a hook assembly base 134, one or more hook assembly tracks 136, and an actuator connector 138. The hook assembly base 134 supports the hooks 132, the hook assembly tracks 136, and the actuator connector 138. In particular, the hooks 132, the hook assembly tracks 136 and the actuator connector 138 are coupled to the hook assembly base 134. The hooks 132 are coupled to a bottom side of the hook assembly base 134 and are spaced laterally about the hook assembly base 134. The hook assembly tracks 136 are coupled to the bottom side of the hook assembly base 134 between the hooks 132 and extend parallel with the hooks 132. The hook assembly tracks 136 are movably coupled to the frame assembly tracks 123 such that the hook assembly 130 can move along the frame assembly tracks 123. The actuator connector 138 is coupled to a top side of the hook assembly base 134 and includes an actuator shaft connector 139. The actuator shaft 142 is coupled to the actuator shaft connector 139 such that the actuator shaft 142 extends and retracts the hook assembly 130 when the actuator 140 extends and retracts the actuator shaft 142. The hook assembly tracks 136 and the actuator connector 138 are coupled to the hook assembly base 134 by one or more fastening mechanisms 137, such as, for example, screws, bolts, or the like. The hook assembly tracks 136 and the actuator connector 138 can be coupled to the hook assembly base 134 by, for example, welding, or the like. In some embodiments, one or more of the hooks 132, the hook assembly base 134, the hook assembly tracks 136, or the actuator connector 138 formed together to form a single, unitary component.

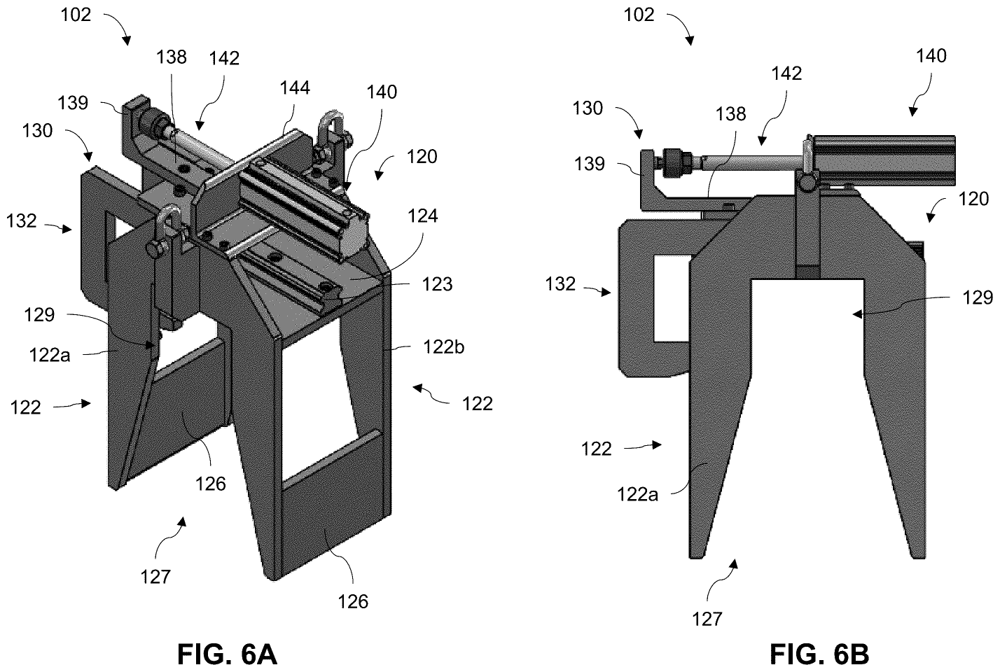

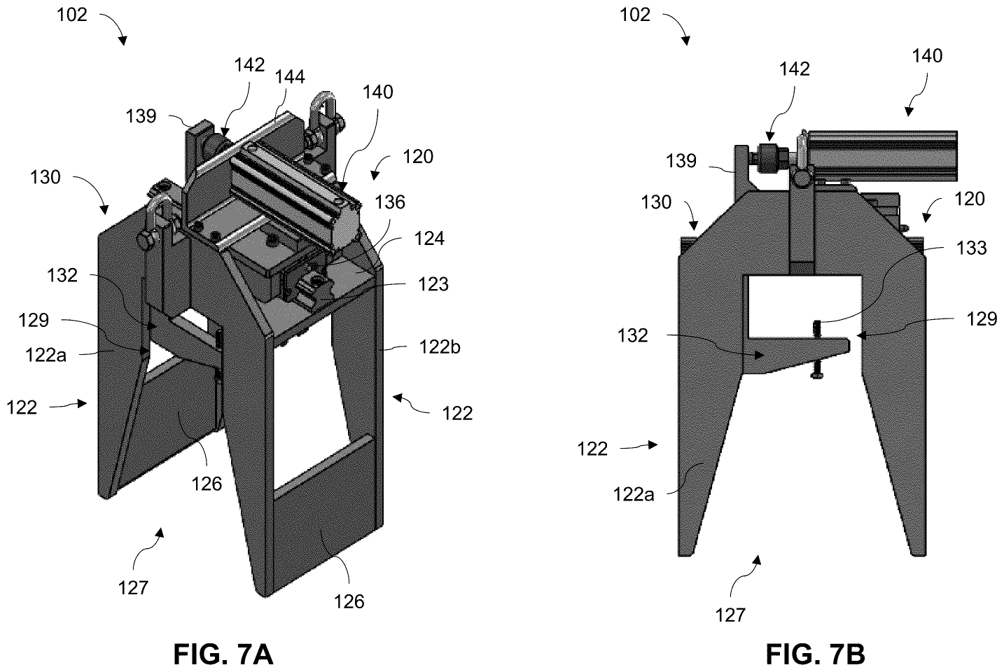

FIG. 6A is a perspective view of the wall grabbing device 102 in an extended position, according to the present disclosure. FIG. 6B is a side plan view of the wall grabbing device 102 in the extended position, according to the present disclosure. FIG. 7A is a perspective view of the wall grabbing device 102 in a retracted position, according to the present disclosure. FIG. 7B is a side plan view of the wall grabbing device 102 in the retracted position, according to the present disclosure.

With reference to FIGS. 6A and 6B, the wall grabbing system 100 controls the wall grabbing device 102 to extend the hook assembly 130 to the extended position. For example, the actuator 140 extends the actuator shaft 142 to extend the hook assembly 130 and the hook assembly 130 moves along the frame assembly tracks 123. The hook assembly 130 moves along the frame assembly tracks 123 such that the hook assembly 130 moves with respect to the frame assembly 120.

The wall grabbing system 100 then controls the wall grabbing device 102 to move the wall grabbing device 102 above a wall structure 10. The wall grabbing system 100 positions the wall grabbing device 102 between two studs 14 such that the hook assembly 130 is aligned with a wall cavity 16 between the two studs 14. In particular, the wall grabbing system 100 aligns the tapered wall guide portion 127 of the wall guides 122 with the wall frame 12 of the wall structure 10. The wall grabbing system 100 then lowers the wall grabbing device 102 to engage the wall structure 10. In particular, the wall grabbing device 102 engages the top portion of the wall frame 12. As the wall grabbing device 102 is lowered onto the wall structure 10, the tapered wall guide portion 127 of the wall guides 122 guides the wall frame 12 towards the straight wall guide portion 129 such that the wall frame 12 is squared in the straight wall guide portion 129 when the wall grabbing device 102 engages the wall structure 10, as shown in FIGS. 1A-1B. The wall grabbing device 102 is then in an engaged positioned with the wall structure 10.

With reference to FIGS. 1A-1B and 7A-7B, the wall grabbing system 100 then controls the wall grabbing device 102 to retract the hook assembly 130 to the retracted position, also referred to as a grabbing position. For example, the actuator 140 retracts the actuator shaft 142 to retract the hook assembly 130. The hook assembly 130 moves along the frame assembly tracks 123 such that the hook assembly 130 moves with respect to the frame assembly 120. As the hook assembly 130 is retracted, the hooks 132 slide underneath top portion of the wall frame 12 to grab the wall structure 10. The rod member 133 engages the wall frame 12 such that the wall grabbing device 102 securely grabs the wall structure 10. The wall grabbing device 102 is then in the grabbing position, as shown in FIGS. 1A and 1B. When the wall grabbing device 102 is in the grabbing position, the wall grabbing system 100 lifts the wall grabbing device 102, thereby lifting the wall structure 10. For example, the machine 20 lifts the machine attachment devices 21, thereby lifting the machine attachment frame 104, the wall grabbing device 102, and the wall structure 10. The wall grabbing system 100 can then transport the wall structure 10 to a desired location. For example, the machine 20 can transport the wall structure 10 to a location for assembling the wall structure 10 in the modular construction unit.

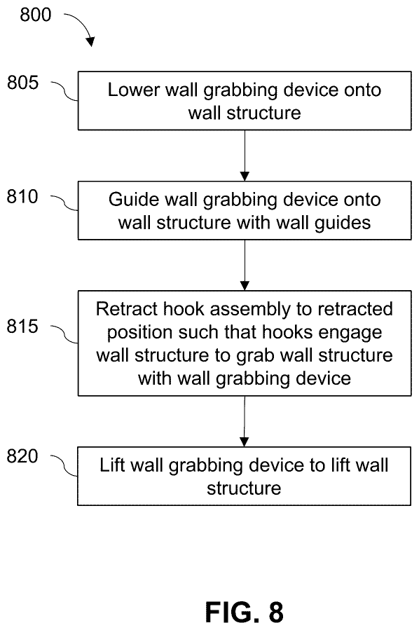

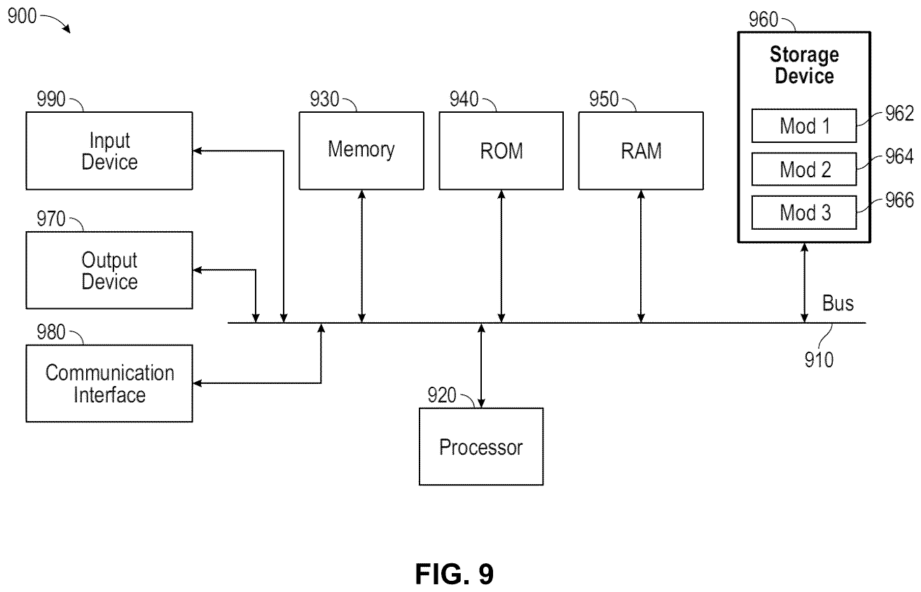

FIG. 8 is a flow diagram of a method 800 of grabbing a wall structure for a modular construction unit, according to the present disclosure. The method 800 can include any of the operations detailed herein with respect to FIGS. 1A to 7B, in any order, and any combinations thereof. The method 800 can be performed by a processor of a computing device (e.g., the computing device 900 of FIG. 9), either manually by an operator controlling the machine 20, or automatically such that the wall grabbing system 100 is automated.

In step 805, the method 800 includes lowering the wall grabbing device 102 onto the wall structure 10. In step 810, the method 800 includes guiding the wall grabbing device 102 onto the wall structure 10 with the one or more wall guides 122 as the wall grabbing device 102 is lowered onto the wall structure 10. When the wall grabbing device 102 is on the wall structure 10, in step 815, the method 800 includes retracting the hook assembly 130 to a retracted position such that the one or more hooks 132 engage the wall structure 10 to grab the wall structure 10 with the wall grabbing device 102. In step 820, the method 800 includes lifting the wall grabbing device 102 to lift the wall structure 10. Thus, the wall grabbing system 100 can grab and lift the wall structure 10 and move the wall structure 10 to a location for installing the wall structure 10 in the modular construction unit.

FIG. 9 illustrates a computing device 900 for controlling aspects of the wall grabbing system 100, according to the present disclosure. The computing device 900 can carry out instructions for controlling the components of the wall grabbing system 100, such as, for example, the machine 20 and the wall grabbing device 102 (e.g., the actuator 140). While a single computing device 900 is illustrated in FIG. 9, the wall grabbing system 100 can include any number of computing devices 900 for controlling the components thereof, and performing the method of grabbing wall structures for the modular construction unit.

The computing device 900 includes a processing unit (CPU or processor) 920 and a system bus 910 that couples various system components including a memory 930 such as read-only memory (ROM) 940 and random-access memory (RAM) 950 to the processor 920. The computing device 900 can include a cache of high-speed memory connected directly with, in close proximity to, or integrated as part of the processor 920. The computing device 900 copies data from the memory 930 and/or the storage device 960 to the cache for quick access by the processor 920. In this way, the cache provides a performance boost that avoids processor 920 delays while waiting for data. These and other modules can control or be configured to control the processor 920 to perform various actions. Other memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general-purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer-readable storage media provide nonvolatile storage of computer-readable instructions, data structures, program modules and other data for the computing device 900. In one aspect, a hardware module that performs a particular function includes the software component stored in a tangible computer-readable storage medium in connection with the necessary hardware components, such as the processor 920, system bus 910, output device 970, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 900 is a small, handheld computing device, a desktop computer, or a computer server.

Although the exemplary embodiment described herein employs the storage device 960, other types of computer-readable media which can store data that are accessible by a computer, such as magnetic cassettes, flash memory cards, digital versatile disks, cartridges, random-access memories (RAMs) 950, and read-only memory (ROM) 940, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art, such as, for example, a display. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

Further aspects of the present disclosure are provided by the subject matter of the following clauses.

A wall grabbing system for grabbing a wall structure of a modular construction unit, the wall grabbing system comprising a wall grabbing device coupled to the machine attachment structure, a frame assembly having one or more wall guides and a hook assembly coupled to the frame assembly between the one or more wall guides, the hook assembly having one or more hooks configured to engage the wall structure, an actuator coupled to the frame assembly and having an actuator shaft coupled to the hook assembly, wherein the actuator moves the hook assembly from an extended position to a retracted position such that the one or more hooks engage the wall structure in the retracted position to grab the wall structure.

The wall grabbing system of the preceding clause, wherein each of the one or more wall guides includes a tapered guide portion and a straight wall guide portion, the tapered guide portion configured to guide the wall structure towards the straight wall guide portion as the wall grabbing device is lowered onto the wall structure.

The wall grabbing system of any preceding clause, wherein the one or more wall guides includes a first wall guide and a second wall guide, and the frame assembly further includes one or more wall guide connector plates that extend from the first wall guide to the second wall guide for coupling the second wall guide to the first wall guide.

The wall grabbing system of any preceding clause, wherein the frame assembly includes one or more frame assembly tracks, and the hook assembly includes one or more hook assembly tracks that are movably coupled to the frame assembly tracks such that the hook assembly moves long the frame assembly tracks with respect to the frame assembly.

The wall grabbing system of any preceding clause, wherein the one or more hooks each includes a rod member that extends vertically from a respective hook and is configured to engage the wall structure when the one or more hooks engage the wall structure.

The wall grabbing system of any preceding clause, wherein the hook assembly includes a hook assembly base, and the one or more hooks include a first hook and a second hook that are coupled to the hook assembly base.

The wall grabbing system of any preceding clause, wherein the hook assembly includes an actuator connector having an actuator shaft connector, and the actuator shaft of the actuator is coupled to the actuator shaft connector such that the actuator extends the actuator shaft to extend the hook assembly and retracts the actuator shaft to retract the hook assembly.

The wall grabbing system of any preceding clause, wherein the frame assembly includes a frame assembly base, the one or more wall guides are coupled on opposite lateral sides of the frame assembly base, and the hook assembly is movably coupled on a top side of the frame assembly base such that the one or more hooks extend beyond a bottom side of the frame assembly base.

The wall grabbing system of any preceding clause, further comprising a wall grabbing device coupling coupled to the machine attachment structure, and the wall grabbing device includes a chain that is hooked on the wall grabbing device coupling to couple the wall grabbing device to the machine attachment structure.

The wall grabbing system of any preceding clause, further comprising a machine having one or more attachment devices, wherein the machine attachment structure includes one or more machine attachment slots, and the machine inserts the one or more attachment devices into the one or more machine attachment slots to lift the wall grabbing device.

A method of grabbing a wall structure of a modular construction unit. The method comprises lowering a wall grabbing device onto the wall structure, guiding the wall grabbing device onto the wall structure with one or more wall guides of a frame assembly as the wall grabbing device is lowered onto the wall structure, when the wall grabbing device is on the wall structure, retracting a hook assembly of the wall grabbing device to a retracted position such that one or more hooks of the hook assembly engage the wall structure to grab the wall structure with the wall grabbing device, and lifting the wall grabbing device to lift the wall structure.

The method of the preceding clause, wherein each of the one or more wall guides includes a tapered guide portion and a straight wall guide portion, and the method further comprises guiding, with the tapered guide portion, the wall grabbing device onto the wall structure towards the straight wall guide portion, and engaging the wall structure with the straight wall guide portion the tapered guide portion configured to guide the wall structure towards the straight wall guide portion as the wall grabbing device is lowered onto the wall structure.

The method of any preceding clause, wherein the one or more wall guides includes a first wall guide and a second wall guide, and the frame assembly further includes one or more wall guide connector plates that extend from the first wall guide to the second wall guide for coupling the second wall guide to the first wall guide.

The method of any preceding clause, wherein the frame assembly includes one or more frame assembly tracks, and the hook assembly includes one or more hook assembly tracks that are movably coupled to the frame assembly tracks, and the method further comprises moving the hook assembly along the frame assembly tracks with respect to the frame assembly.

The method of any preceding clause, wherein the one or more hooks each includes a rod member that extends vertically from a respective hook, and the method further comprises engaging the wall structure with the rod member when the one or more hooks engage the wall structure.

The method of any preceding clause, wherein the hook assembly includes a hook assembly base, and the one or more hooks include a first hook and a second hook that are coupled to the hook assembly base.

The method of any preceding clause, wherein the hook assembly includes an actuator connector having an actuator shaft connector, and the actuator shaft of the actuator is coupled to the actuator shaft connector, and the method further comprises extending the actuator shaft to extend the hook assembly and retracting the actuator shaft to retract the hook assembly.

The method of any preceding clause, wherein the frame assembly includes a frame assembly base, the one or more wall guides are coupled on opposite lateral sides of the frame assembly base, and the hook assembly is movably coupled on a top side of the frame assembly base such that the one or more hooks extend beyond a bottom side of the frame assembly base.

The method of any preceding clause, wherein the wall grabbing device is coupled to a machine attachment structure by a wall grabbing device coupling coupled to the machine attachment structure, and the wall grabbing device includes a chain that is hooked on the wall grabbing device coupling to couple the wall grabbing device to the machine attachment structure.

The method of any preceding clause, wherein the wall grabbing device is coupled to a machine attachment structure, the machine attachment structure including one or more machine attachment slots, and the method further comprises inserting one or more attachment devices of a machine into the one or more machine attachment slots of the machine attachment structure, and lifting the one or more attachment devices to lift the wall grabbing device.

Although the foregoing description is directed to the preferred embodiments, it is noted that other variations and modifications will be apparent to those skilled in the art and may be made without departing from the spirit or scope of the disclosure. Moreover, features described in connection with one embodiment may be used in conjunction with other embodiments, even if not explicitly stated above.

1. A wall grabbing system for grabbing a wall structure of a modular construction unit, the wall grabbing system comprising:
a machine attachment structure; and
a wall grabbing device coupled to the machine attachment structure, the wall grabbing device comprising:
a frame assembly having one or more wall guides;
a hook assembly coupled to the frame assembly between the one or more wall guides, the hook assembly having one or more hooks configured to engage the wall structure; and
an actuator coupled to the frame assembly and having an actuator shaft coupled to the hook assembly, wherein the actuator moves the hook assembly from an extended position to a retracted position such that the one or more hooks engage the wall structure in the retracted position to grab the wall structure.

2. The wall grabbing system of claim 1, wherein each of the one or more wall guides includes a tapered guide portion and a straight wall guide portion, the tapered guide portion configured to guide the wall structure towards the straight wall guide portion as the wall grabbing device is lowered onto the wall structure.

3. The wall grabbing system of claim 1, wherein the one or more wall guides includes a first wall guide and a second wall guide, and the frame assembly further includes one or more wall guide connector plates that extend from the first wall guide to the second wall guide for coupling the second wall guide to the first wall guide.

4. The wall grabbing system of claim 1, wherein the frame assembly includes one or more frame assembly tracks, and the hook assembly includes one or more hook assembly tracks that are movably coupled to the frame assembly tracks such that the hook assembly moves long the frame assembly tracks with respect to the frame assembly.

5. The wall grabbing system of claim 1, wherein the one or more hooks each includes a rod member that extends vertically from a respective hook and is configured to engage the wall structure when the one or more hooks engage the wall structure.

6. The wall grabbing system of claim 1, wherein the hook assembly includes a hook assembly base, and the one or more hooks include a first hook and a second hook that are coupled to the hook assembly base.

7. The wall grabbing system of claim 1, wherein the hook assembly includes an actuator connector having an actuator shaft connector, and the actuator shaft of the actuator is coupled to the actuator shaft connector such that the actuator extends the actuator shaft to extend the hook assembly and retracts the actuator shaft to retract the hook assembly.

8. The wall grabbing system of claim 1, wherein the frame assembly includes a frame assembly base, the one or more wall guides are coupled on opposite lateral sides of the frame assembly base, and the hook assembly is movably coupled on a top side of the frame assembly base such that the one or more hooks extend beyond a bottom side of the frame assembly base.

9. The wall grabbing system of claim 1, further comprising a wall grabbing device coupling coupled to the machine attachment structure, and the wall grabbing device includes a chain that is hooked on the wall grabbing device coupling to couple the wall grabbing device to the machine attachment structure.

10. The wall grabbing system of claim 1, further comprising a machine having one or more attachment devices, wherein the machine attachment structure includes one or more machine attachment slots, and the machine inserts the one or more attachment devices into the one or more machine attachment slots to lift the wall grabbing device.

11. A method of grabbing a wall structure of a modular construction unit, the method comprising:
lowering a wall grabbing device onto the wall structure;
guiding the wall grabbing device onto the wall structure with one or more wall guides of a frame assembly as the wall grabbing device is lowered onto the wall structure;
when the wall grabbing device is on the wall structure, retracting a hook assembly of the wall grabbing device to a retracted position such that one or more hooks of the hook assembly engage the wall structure to grab the wall structure with the wall grabbing device; and
lifting the wall grabbing device to lift the wall structure.

12. The method of claim 11, wherein each of the one or more wall guides includes a tapered guide portion and a straight wall guide portion, and the method further comprises guiding, with the tapered guide portion, the wall grabbing device onto the wall structure towards the straight wall guide portion, and engaging the wall structure with the straight wall guide portion the tapered guide portion configured to guide the wall structure towards the straight wall guide portion as the wall grabbing device is lowered onto the wall structure.

13. The method of claim 11, wherein the one or more wall guides includes a first wall guide and a second wall guide, and the frame assembly further includes one or more wall guide connector plates that extend from the first wall guide to the second wall guide for coupling the second wall guide to the first wall guide.

14. The method of claim 11, wherein the frame assembly includes one or more frame assembly tracks, and the hook assembly includes one or more hook assembly tracks that are movably coupled to the frame assembly tracks, and the method further comprises moving the hook assembly along the frame assembly tracks with respect to the frame assembly.

15. The method of claim 11, wherein the one or more hooks each includes a rod member that extends vertically from a respective hook, and the method further comprises engaging the wall structure with the rod member when the one or more hooks engage the wall structure.

16. The method of claim 11, wherein the hook assembly includes a hook assembly base, and the one or more hooks include a first hook and a second hook that are coupled to the hook assembly base.

17. The method of claim 11, wherein the hook assembly includes an actuator connector having an actuator shaft connector, and the actuator shaft of the actuator is coupled to the actuator shaft connector, and the method further comprises extending the actuator shaft to extend the hook assembly and retracting the actuator shaft to retract the hook assembly.

18. The method of claim 11, wherein the frame assembly includes a frame assembly base, the one or more wall guides are coupled on opposite lateral sides of the frame assembly base, and the hook assembly is movably coupled on a top side of the frame assembly base such that the one or more hooks extend beyond a bottom side of the frame assembly base.

19. The method of claim 11, wherein the wall grabbing device is coupled to a machine attachment structure by a wall grabbing device coupling coupled to the machine attachment structure, and the wall grabbing device includes a chain that is hooked on the wall grabbing device coupling to couple the wall grabbing device to the machine attachment structure.

20. The method of claim 11, wherein the wall grabbing device is coupled to a machine attachment structure, the machine attachment structure including one or more machine attachment slots, and the method further comprises inserting one or more attachment devices of a machine into the one or more machine attachment slots of the machine attachment structure, and lifting the one or more attachment devices to lift the wall grabbing device.
